(19) United States
(12) Patent Application Publication
(10) Pub. No.: US 2022/0384825 A1
(43) Pub. Date: Dec. 1, 2022

(54) METHOD FOR ACTUATING A METERING VALVE

(71) Applicant: Robert Bosch GmbH, Stuttgart (DE)

(72) Inventor: Hans-Christoph Magel, Reutlingen (DE)

(21) Appl. No.: 17/765,496

(22) PCT Filed: Sep. 18, 2020
(86) PCT No.: PCT/EP2020/076086

§ 371 Date: Mar. 31, 2022

(30) Foreign Application Priority Data
Oct. 2, 2019 (DE) 10 2019 215 211.2

(51) Int. Cl. H01M 8/04089; H01M 8/04119; H01M 8/04082; H01M 8/04223; H01M 8/04303; H01M 8/04746

(52) U.S. Cl. CPC H01M 8/04097; H01M 8/04179; H01M 8/04201; H01M 8/04253; H01M 8/04303; H01M 8/04753

(57) ABSTRACT

The invention relates to a method for deactivating a fuel cell system (10) comprising a jet pump (28) for conveying an anode-side gas flow in a recirculation path (26), wherein the jet pump (28) comprises a metering valve (36) for metering H₂. While the fuel cell system (10) is cooling, a flow passes through a drive nozzle (46) at least once in order to discharge condensed water. The t invention additionally relates to a jet pump (28) comprising a metering valve (36) and to the use of the method in order to deactivate a fuel cell system (10).

### BACKGROUND OF THE INVENTION

The invention relates to a method for actuating a metering valve as part of a jet pump in a fuel cell system, and to the metering valve as part of a jet pump.

DE 10 2011 114 797 A1 relates to a method for operating a fuel cell system. At least one fuel cell is provided which has an anode chamber and a cathode chamber, wherein fuel (H₂) is fed from a fuel source to the anode chamber and unconsumed exhaust gas is recirculated by means of a gas jet pump from the anode chamber into the fuel flowing to the anode chamber, and the gas jet pump comprises a heatable nozzle. The heating of the nozzle of the gas jet pump is performed only when no fuel is flowing through the gas jet pump.

WO 2013 045 048 A1 relates to a method for deactivating a fuel cell system. An anode recirculation means comprises a gas jet pump for inducting an anode exhaust gas, wherein the gas jet pump is driven by a fuel gas flow that flows via a valve and a nozzle into the gas jet pump. While the fuel cell system cools, a pressure is maintained in the region between the valve and the nozzle, which pressure is equal to or higher than the pressure prevailing in the region of the anode recirculation means.

Gas valves with solenoid actuators are known for the purposes of metering hydrogen for example in a fuel cell. For example, such gas valves are configured as proportional valves. In a fuel cell system, within the anode circuit, a jet pump is used to assist the necessary recirculation of the anode gas. Such a jet pump comprises a motive nozzle which is passed through by the hydrogen flow of the gas metering valve. The motive nozzle of the jet pump is part of the gas metering valve. The gas metering valve is positioned in the jet pump such that the outlet of the motive nozzle of the valve is situated axially upstream of the mixing pipe of the jet pump, and a chamber for the induction is formed around the motive nozzle.

In the case of the abovementioned arrangement comprising the integration of j et pump and gas metering valve, the jet pump drives the humid anode gas. Therefore, in the event of adverse cooling situations after the shutdown of the fuel cell, moisture can condense in the nozzle bore of the motive nozzle. In the presence of correspondingly low ambient temperatures, in the worst case, the nozzle can freeze up. In this case, metering of hydrogen is no longer possible, and the fuel cell can no longer be started.

### SUMMARY OF THE INVENTION

According to the invention, a method for deactivating a fuel cell system having a jet pump for conveying an anode-side gas flow in a recirculation path, with an integrated metering valve for metering H₂, is proposed. While the fuel cell system is cooling, a motive nozzle is passed through by a pulse-like flow at least once for the purposes of discharging condensed water.

By means of the method proposed according to the invention, after a first cooling phase after the major part of the moisture contained in the anode-gas-side gas flow has condensed, said moisture can be discharged from the motive nozzle. It is thus possible, for example, for a vehicle that is driven by means of a fuel cell system to be parked outdoors even when outside temperatures are low, for example in cold seasons.

In a further embodiment of the method according to the invention, a further pulse-like passage of flow through the motive nozzle may be initiated shortly before the freezing point is reached. In order to ensure that a restart of the fuel cell system is ensured in the presence of low outside temperatures, the motive nozzle is passed through once again by a pulse-like flow shortly before the freezing point is reached, such that all water that may have been deposited is reliably removed from the motive nozzle.

In one refinement of the method proposed according to the invention, the motive nozzle is charged with fuel, in particular with H₂.

In one refinement of the method proposed according to the invention, the pulse-like passage of flow through the motive nozzle is performed while the fuel cell system is cooling to a temperature between 20° C. and 30° C. It can thus advantageously be ensured that a major part of the moisture contained in the anode gas is already condensed out, and condensed water is thus removed by means of a first pulse-like passage of flow through the motive nozzle.

In the method proposed according to the invention, the pulse-like passage of flow is performed with a sufficient inlet pressure in the range from 3 bar to 16 bar.

In the method according to the invention, at least the pulse-like passage of flow is performed in a time period of 0.01 s to 0.1 s.

In the method proposed according to the invention, at the actuation times of the metering valve for the implementation of the pulse-like passage of flow, a pressure briefly prevails in the fuel inlet, that is to say in the H₂ inlet, which is higher than the pressure that prevails in the induction region around the motive nozzle. It is thus ensured that no medium from the anode, in particular no medium that contains moisture, can flow back into the motive nozzle or the metering valve.

The invention furthermore relates to a jet pump with integrated metering valve for conveying an anode-side gas flow in accordance with the above method, having a motive nozzle which projects into an induction region of the jet pump and the fuel inlet of which, in particular an H₂ inlet, is opened or closed by means of the metering valve, wherein the motive nozzle has a minimum dead volume between the nozzle outlet and the valve seat. The minimum dead volume lies for example in a range between 70 mm³ and 200 mm³.

The jet pump with integrated metering valve is constructed such that the nozzle outlet of the motive nozzle is situated axially upstream of a mixing pipe of the jet pump, and an induction region of the recirculation path extends around the motive nozzle.

The invention furthermore relates to the use of the method for deactivating a fuel cell system which serves for the drive of a vehicle.

The solution proposed according to the invention advantageously allows a fuel cell system to be started without disruption after it has been deactivated, in particular in the presence of low outside temperatures that occur in cold seasons. Adverse cooling situations after the shutdown of the fuel cell can be allowed for by means of the solution proposed according to the invention. After a first cooling phase, after which the fuel cell system is for example at a temperature of 20° C. to 30° C., to name one exemplary temperature range, has elapsed, a first discharge of water that has condensed out of anode gas is performed by way of a pulse-like passage of flow through the motive nozzle.

In order to ensure a reliable restart of the fuel cell system even in the presence of low outside temperatures, it is possible by means of the method proposed according to the invention for another pulse-like passage of flow through the motive nozzle to be initiated shortly before the freezing point is reached, such that water that has possibly collected can be removed from the motive nozzle, and no blockage of the motive nozzle with ice occurs in the presence of outside temperatures below the freezing point. This would prevent a restart of the fuel cell system. This can be remedied by means of the solution proposed according to the invention.

The method is advantageously applied to a jet pump with integrated metering valve, wherein the jet pump with integrated metering valve serves for transporting an anode-side gas flow. The method proposed according to the invention allows for the fact that the motive nozzle of the jet pump is situated in the region of moisture-containing anode gas. By means of the method proposed according to the invention, a major part of the moisture, that is to say water, which has condensed out in the anode gas can be discharged out of the motive nozzle already after the first cooling phase has elapsed. The method is advantageously used with a jet pump with integrated metering valve, wherein, as a result of the integration of the motive nozzle into the jet pump, there is only a minimum dead volume between the nozzle outlet of the motive nozzle and the valve seat, and thus a very short actuation of the metering valve is sufficient to realize a pulse-like passage of flow through the motive nozzle and to discharge water contained therein. Owing to the very short throughflow times, which lie in the range from 0.01 s to 0.1 s, an excessive pressure increase in the anode system of the fuel cell can be avoided.

By means of the method proposed according to the invention, it is ensured that, during the cooling of the fuel cell, the metering valve integrated into the jet pump is actuated until such time as condensed water that is situated in the motive nozzle can be discharged. The actuation of the metering valve may be performed once or several times. Since the actuation takes place already after a first cooling phase has elapsed, when a temperature of 20° C. to 30° C. of the fuel cell system is reached, sufficient gas pressure, that is to say H₂ pressure, is still available in the fuel-side inlet upstream of the metering valve. To ensure the restart of the fuel cell system and to ensure the prevention of freezing-up of the motive nozzle, a further pulse-like passage of flow through the motive nozzle may be initiated shortly before the temperature of the valve, or the ambient temperature, reaches the freezing point.

With the method proposed according to the invention, it is furthermore ensured that, at the actuation time, a pressure prevails in the fuel-side inlet, that is to say the H₂ inlet to the metering valve, which is higher than that which prevails on the discharge side of the jet pump with integrated metering module.

It is thus ensured that no moisture-containing medium flows from the recirculation path back into the motive nozzle and results in undesired accumulations of water therein.

### BRIEF DESCRIPTION OF THE DRAWINGS

Embodiments of the invention will be discussed in more detail on the basis of the drawings and the following description.

In the drawings:

FIG. 1 is a schematic illustration of components of a fuel cell system with recirculation path, jet pump and metering valve, and

FIG. 2 shows a section through a jet pump for transporting an anode-side gas flow, with integrated metering valve for metering H₂.

### DETAILED DESCRIPTION

In the following description of the embodiments of the invention, identical or similar elements are denoted by the same reference designations, wherein no repeated description of said elements in individual cases will be given. The figures illustrate the subject matter of the invention merely schematically.

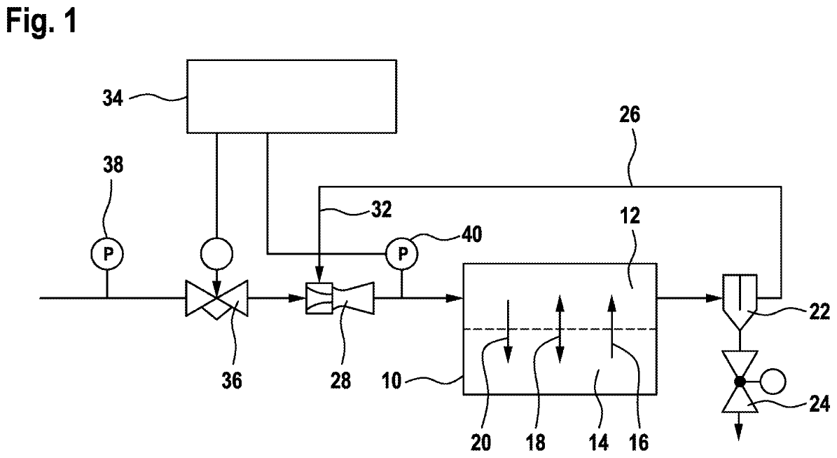

FIG. 1 illustrates the components of a fuel cell system with metering valve, jet pump, fuel cell and control unit.

It can be seen from the illustration of FIG. 1 that a fuel cell system 10, of which one fuel cell is illustrated by way of example here, comprises an anode-side path 12 and a cathode-side path 14. Within the fuel cell system 10, a diffusion of N₂ 16 takes place from the cathode-side path 14 from the ambient air into the anode-side path 12. An exchange of water 18 takes place between the anode-side path 12 and the cathode-side path 14, and a diffusion of H₂ 20 also takes place from the anode-side path into the cathode-side path 14.

Situated at the outlet side of the fuel cell system 10 is a separator 22, at the bottom side of which a drain valve 24 is arranged. By means of the separator 22, liquid water, that is to say hydrogen, can be separated off from the anode-side gas flow that is circulated in a recirculation path 26.

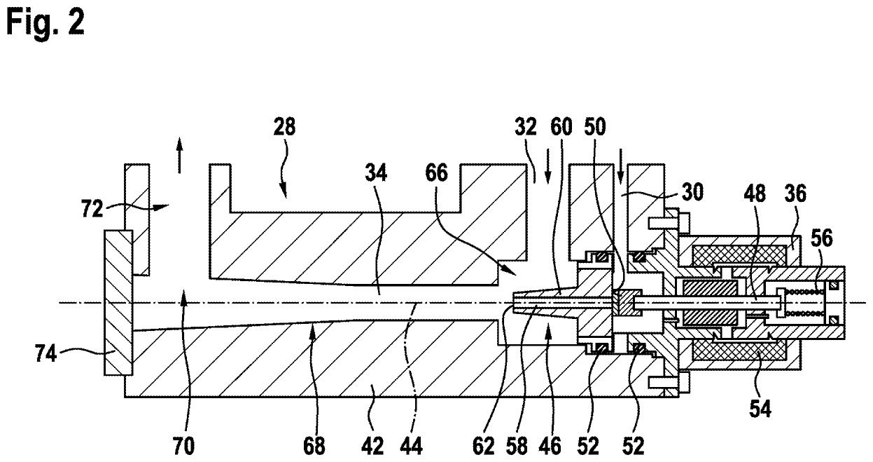

It can also be seen from FIG. 1 that the recirculation path 26 runs from the separator 22 to a jet pump 28. The jet pump 28 is one into which a metering valve 36 is integrated (cf. in particular the illustration as per FIG. 2). The jet pump 28 comprises a recirculation inlet 32 of the recirculation path 26, and a fuel inlet that is not illustrated in FIG. 1. The recirculation path 26 may comprise a recirculation blower (not illustrated in any more detail here) in order to assist the conveyance of the fluid flow in the recirculation path 26. A first pressure sensor 38 is situated upstream of the metering valve 36; a second pressure sensor 40 is situated downstream of the metering valve 36, which second pressure sensor follows the jet pump 28 in a flow direction. Both the metering valve 36 and the second pressure sensor 40 are connected to a control unit 34.

FIG. 2 illustrates a jet pump 28 with integrated metering valve 36 in section.

FIG. 2 shows that the jet pump 28 comprises an integrated, laterally flange-mounted metering valve 36. The jet pump 28 comprises a pump body 42. Extending through said pump body 42 is a mixing pipe 64, the mixing pipe axis of which is denoted by reference designation 44. A motive nozzle 46 is arranged, coaxially with respect to the mixing pipe axis 44, in the pump body 42. A nozzle outlet of the motive nozzle 46 is denoted by reference designation 62 and is likewise aligned with the mixing pipe axis 44. Here, the motive nozzle 46 is part of the metering valve 36 and, on the side situated opposite the nozzle outlet 62, has a valve seat 50 that is opened up, or can be actuated, by a valve plunger 48. Both the motive nozzle 46, or the separate insert thereof, and a flange of the metering valve 36 are received in the pump body 42, and sealed off against the latter, via seals 52.

FIG. 2 furthermore shows that the metering valve 36, or the valve plunger 48 thereof, are actuatable by means of a magnetic coil 54, wherein the actuation of the magnet coil 54 is performed by means of the control unit 34 illustrated in FIG. 1. The valve plunger 48 operates counter to a valve spring 56 which is received, coaxially with respect to the valve plunger 48, in the body of the metering valve 36, wherein the valve spring 56 is supported on a cover part of the metering valve 36.

It can be seen from the illustration of FIG. 2 that the motive nozzle 46 has a nozzle channel 58. The nozzle channel 58 is delimited at one side by the nozzle outlet 62 and at the other side by the valve seat 50. As can also be seen from FIG. 2, the motive nozzle 46 is surrounded by an induction region 66 in the pump body 42. A recirculation inlet 32 opens into the induction region 66. A fuel inlet, that is to say the H₂ inlet 30, opens out above the valve seat 50 of the motive nozzle 46.

The two inlets, the recirculation inlet 32 and the H₂ inlet 30, are sealed off with respect to one another in the pump body 42 of the jet pump 28. The mixing pipe 64 extends from the induction region 66, which mixing pipe transitions into a diffuser part 68. Said diffuser part likewise runs symmetrically with respect to the mixing pipe axis 44. The diffuser part 68 of the mixing pipe 64 transitions into an outflow region 70 which, at one side, is closed by a cover 74 and, at the other side, has an outlet 72, which opens into the recirculation path 26 again.

The method proposed according to the invention for deactivating a fuel cell system is performed preferably with the jet pump 28 illustrated in section in FIG. 2, with integrated metering valve 36 for metering the fuel, in particular H₂. After the fuel cell system 10 as per FIG. 1 has been deactivated, the cooling phase thereof occurs until the fuel cell system has reached a temperature of between 20° C. and 30° C. At this temperature, a major part of the moisture contained in the anode gas, that is to say in the gas transported in the recirculation path 26, has condensed out, in particular in the region of the passage of the nozzle channel 58 of the motive nozzle 46. After a predetermined period of time has elapsed, or after this temperature range, that is to say 20° C. to 30° C., has been reached, the control unit 34 performs a pulse-like actuation of the metering valve 36 such that a pulse-like passage of flow through the motive nozzle 46 occurs, whereby condensed water is reliably discharged therefrom.

If it is identified by the control unit 34, or by the temperature sensor assigned thereto, that the ambient temperature is approaching the freezing point, then the control unit 34 may initiate a renewed actuation of the metering valve 36 for a very short period of time shortly before the freezing point is reached. It is thus ensured that a passage of flow through the nozzle channel 58 of the motive nozzle 46 occurs again shortly before the freezing point is reached, such that any condensate that is present in said nozzle channel is reliably removed from the nozzle channel 58 of the motive nozzle 46 already before the freezing point is reached, that is to say before ice begins to form. A further lowering of the ambient temperature is thereafter not of importance, because ice flowing through the nozzle channel 58 cannot be formed as a presence of water, and thus a restart of the fuel cell system 10, for example after a parking phase outdoors in the presence of low outside temperatures, is possible without problems because the nozzle channel 58 is not blocked but is free from ice.

The method proposed according to the invention can be realized in particular in the case of the jet pump 28 with integrated metering valve 36 because, in this design variant, there is a minimum dead volume between the valve seat 50 and the nozzle outlet 62, and a very short actuation of the metering valve 36 by means of the control unit 34 is sufficient to cause a pulse-like passage of flow through the nozzle channel 58 in the manner inherent in the method proposed according to the invention, and to discharge condensed water.

The method proposed according to the invention furthermore ensures that, at the actuation time of the metering valve 36 by the control unit 34, before the pulse-like passage of flow through the motive nozzle, a relatively high pressure prevails on the fuel-side inlet side, that is to say at the H₂ inlet 30. It is thus possible to prevent moisture-containing anode gas from flowing from the outlet side of the jet pump 28 back into the motive nozzle 46, and an introduction of water into the latter does not occur.

The invention is not restricted to the exemplary embodiments described here and the aspects highlighted therein. Rather, numerous modifications that fall within the capabilities of a person skilled in the art are possible within the scope specified by the claims.

1. A method for deactivating a fuel cell system (10) having a jet pump (28) for conveying an anode-side gas flow in a recirculation path (26), wherein the jet pump (28) comprises a metering valve (36) for metering H₂, wherein, while the fuel cell system (10) is cooling, a motive nozzle (46) is passed through by a pulse-like flow at least once for the purposes of discharging condensed water.

2. The method as claimed in claim 1, wherein a further pulse-like passage of flow through the motive nozzle (46) takes place shortly before a freezing point is reached.

3. The method as claimed in claim 1, wherein the motive nozzle (46) is charged with fuel.

4. The method as claimed in claim 1, wherein the pulse-like passage of flow through the motive nozzle (46) is performed while the fuel cell system (10) is cooling to a temperature of 20° C. to 30° C.

5. The method as claimed in claim 1, wherein the pulse-like passage of flow is performed with an inlet pressure in a range from 3 bar to 16 bar.

6. The method as claimed in claim 1, wherein at least the pulse-like passage of flow is performed in a time period of 0.01 s to 0.1 s.

7. The method as claimed in claim 1, wherein, at actuation times of the metering valve (36), a higher pressure prevails in an H₂ inlet (30) than in an induction region (66) around the motive nozzle (46).

8. A jet pump (28) with metering valve (36) for conveying an anode-side gas flow in accordance with the method as claimed in claim 1, having a motive nozzle (46) which projects into an induction region (66) of the jet pump (28) and a fuel inlet of which is opened or closed by the metering valve (36), wherein the motive nozzle (46) has, between a nozzle outlet (62) and a valve seat (50), a minimum dead volume that lies in a range between 70 mm³ and 200 mm³.

9. The jet pump (28) with integrated metering valve (36) as claimed in claim 8, wherein the nozzle outlet (62) of the motive nozzle (46) is situated axially upstream of a mixing pipe (64), and an induction region (66) of the recirculation path (26) extends around the motive nozzle (46).

10. The use of the method as claimed in claim 1 for deactivating a fuel cell system (10) for a drive of a vehicle.

11. The method as claimed in claim 3, wherein the fuel is gaseous H₂.

12. The jet pump (28) with integrated metering valve (36) as claimed in claim 8, wherein the fuel inlet is an H₂ inlet (30).
